(19) United States
(12) Patent Application Publication
(10) Pub. No.: US 2025/0010802 A1
(43) Pub. Date: Jan. 9, 2025

(54) BULL BAR ATTACHMENT SYSTEM

(71) Applicant: Sean Lloyd, Poulsbo, WA (US)

(72) Inventor: Sean Lloyd, Poulsbo, WA (US)

(21) Appl. No.: 18/763,471

(22) Filed: Jul. 3, 2024

Related U.S. Application Data
(60) Provisional application No. 63/511,985, filed on Jul. 5, 2023.

(51) Int. Cl. B60R 9/06; B60R 11/00; B60R 11/06

(52) U.S. Cl. CPC B60R 9/06; B60R 11/06; B60R 2011/004; B60R 2011/0059

(57) ABSTRACT

A bull bar mounting module configured to secure at least one accessory to a bull bar may include a front side, a top side, a rear side, and a bottom side. The bull bar mounting module may include a first slot attachment assembly defined in the front side, a third slot attachment assembly defined in the rear side, and at least first and second mounting portions that are secured together in a manner that substantially prevents disassembly of the mounting module from a bull bar when an accessory is secured to at least one of the front or rear side of the mounting module using the corresponding slot assembly.

### CROSS-REFERENCE TO RELATED PATENT APPLICATION

This is a U.S. non-provisional patent application which claims the benefit of and priority from U.S. provisional patent application No. 63/511,985, filed on Jul. 5, 2023, the contents of which are hereby incorporated by reference in its entirety.

### BACKGROUND

Current production motor vehicles, such as the modern-day automobile, are originally equipped with impact protection components for absorbing a kinetic energy pulse generated from an impact event between the vehicle and an external object. The most prevalent type of impact protection component is the front and rear vehicle bumper structure. A vehicle bumper is normally composed of a high-strength yet deformable crossbeam that is rigidly secured to the body in white (BIW) chassis and covered by an A-surface cladding (more commonly known as a “bumper fascia”). Bumper crossbeams are typically designed to deform in a controlled and predictable manner to optimize impact energy absorption, while the bumper fascia is merely provided as an aesthetically appealing shell for concealing the crossbeam.

Serving as a supplementary protective device, a bull bar device, or simply “bull bar”, may be mounted on or in front of a bumper structure, cantilevered to the chassis of the vehicle. Many bull bars, which are also commonly known as “nudge bars” and “grill guards,” use a web of welded metal tubes to protect the front of a vehicle from stray wildlife, tree branches, and other objects that may dent the bumper fascia, break lamp lenses, damage grilles, and scratch exterior surfaces so as to degrade the vehicle's appearance.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A and 1B are photographs of a representative motor vehicle having a representative bull bar device mounted to the vehicle.

FIGS. 2A-2C and 3-18 depict a first exemplary embodiment of at least part of a bull bar accessory attachment system formed in accordance with the present disclosure.

FIGS. 20-21 depict a second exemplary embodiment of at least part of a bull bar accessory attachment system formed in accordance with the present disclosure.

### SUMMARY

In some aspects, the techniques described herein relate to a bull bar mounting module configured to secure at least one accessory to a bull bar, including: a front side, a top side, a rear side, and a bottom side; a first slot attachment assembly defined in the front side and a third slot attachment assembly defined in the rear side; at least first and second mounting portions that are secured together in a manner that substantially prevents disassembly of the mounting module from a bull bar when an accessory is secured to at least one of the front or rear side of the mounting module using the corresponding slot assembly.

### DETAILED DESCRIPTION

The present disclosure relates generally to bull bars for motor vehicles. More specifically, aspects of this disclosure relate to attachment assemblies for affixing accessories, tools, and other devices to a bull bar.

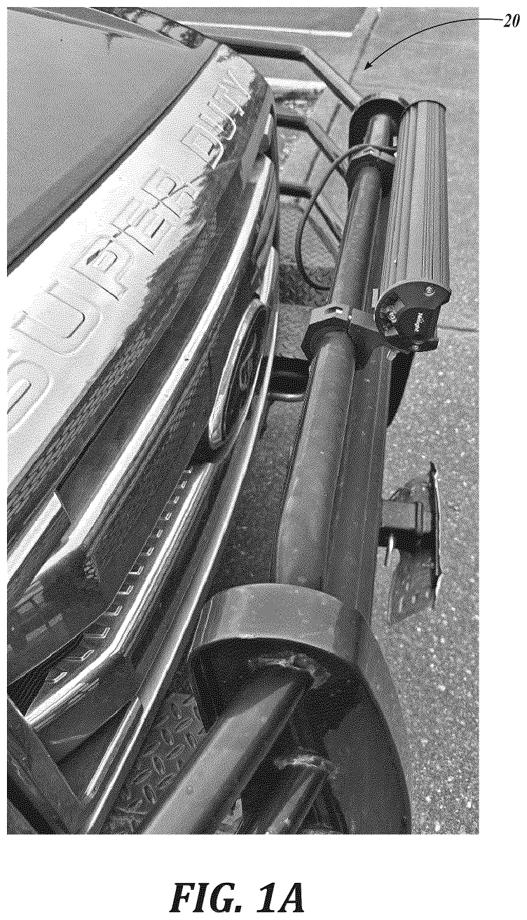

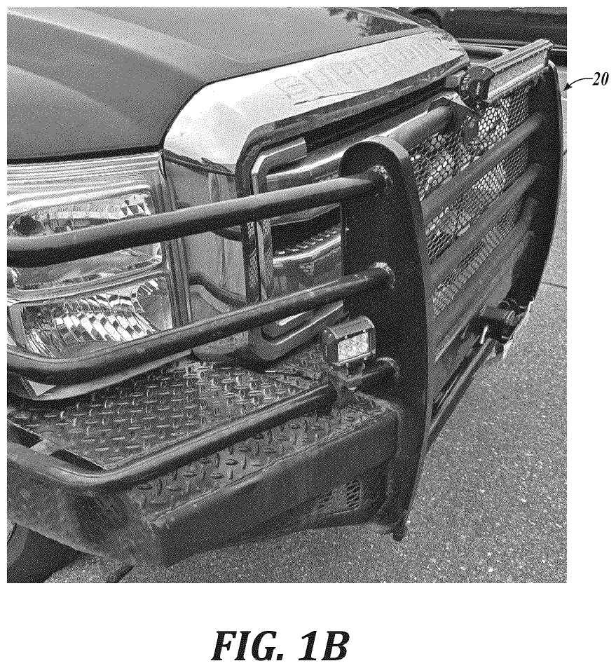

FIGS. 1A and 1B are photographs of a representative motor vehicle having a representative bull bar 20 mounted to the vehicle. The bull bar 20 may serve as an extension of the vehicle frame, upon which additional accessories may mount. The bull bar 20 may be fabricated from high-strength metal, such as powder coated or cold-rolled t-304 stainless steel and tubing. The bull bar 20 may take on other known configurations, locations and attendant features without departing from the intended scope of this disclosure.

A bull bar provides a location for mounting accessories, such as auxiliary lights to brighten the trail, a winch carrier, a tow hook, a hydraulic lift, or other optional equipment and tools (hereinafter sometimes simply referred to as “accessories”). For instance, it may be beneficial to mount accessories such as a shovel, axe, tool box (field/utility box), flash light, fire starter, high lift jack, a vice, or other accessories to the bull bar.

Prior art systems typically use clamping mechanisms or similar devices to mount accessories to the tubing of a bull bar. For instance, in the prior art system shown in FIGS. 1A and 1B, auxiliary lights are mounted to the tubing of the bull bar 20 with a simple clamping mechanism that can be disassembled with a small tool set. Accordingly, prior art bull bar accessory attachment systems leave high end bull bar accessories, such as auxiliary lights and lift systems susceptible to being stolen. Further, prior art devices are limited to mounting a single device to the bull bar.

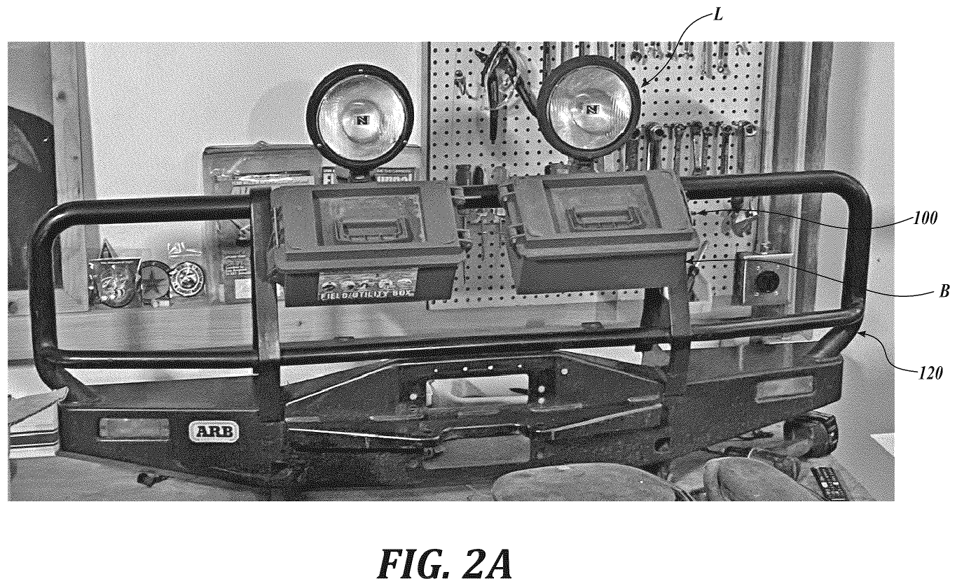

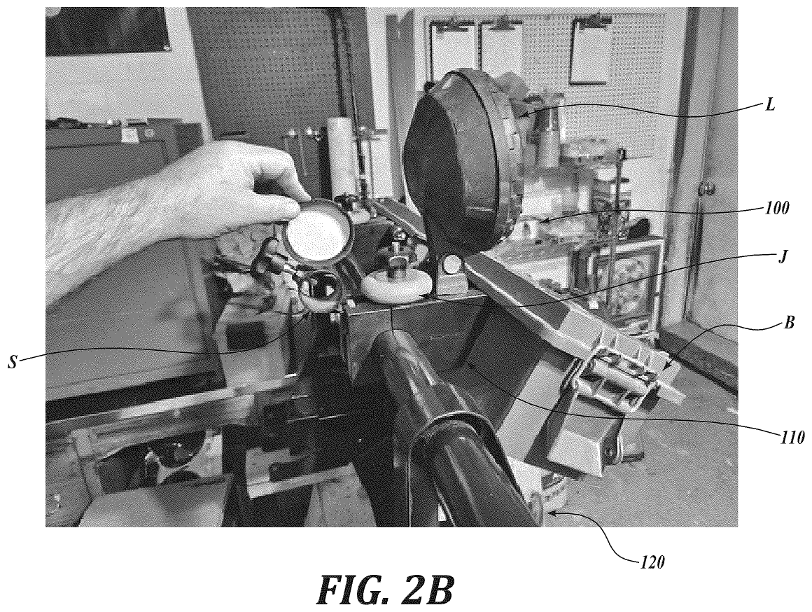

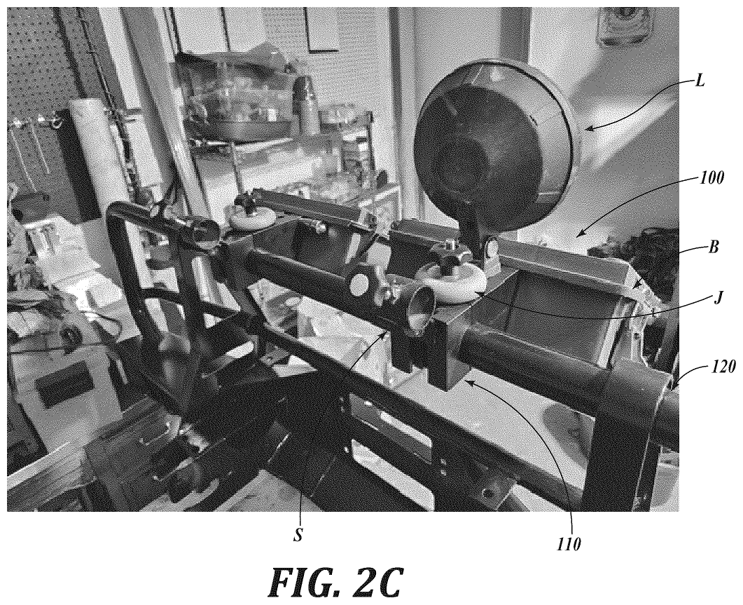

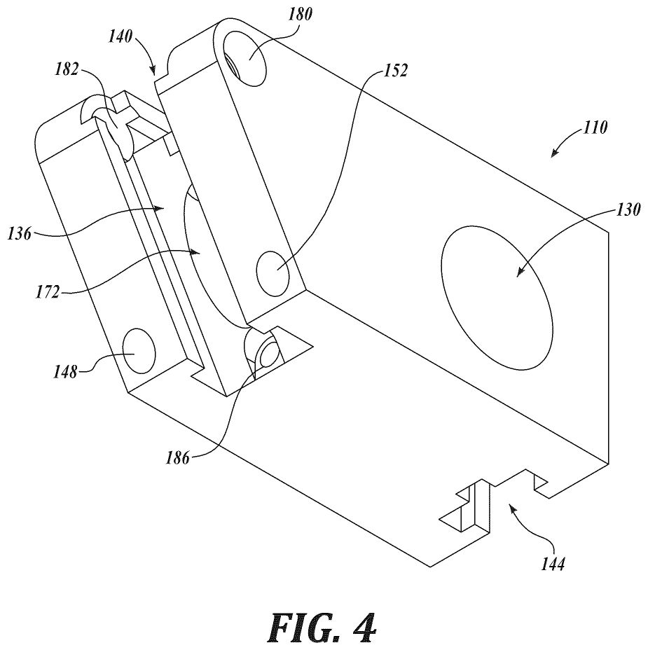

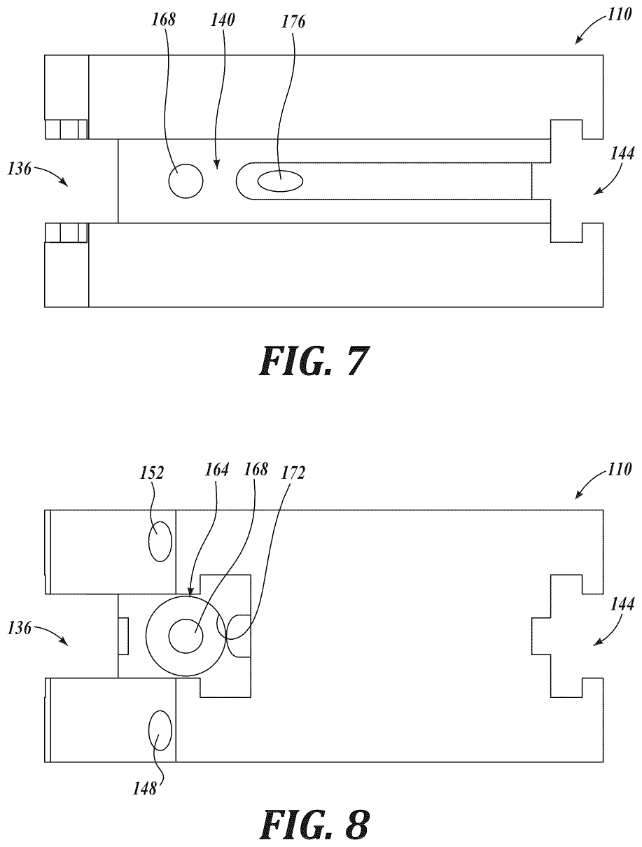

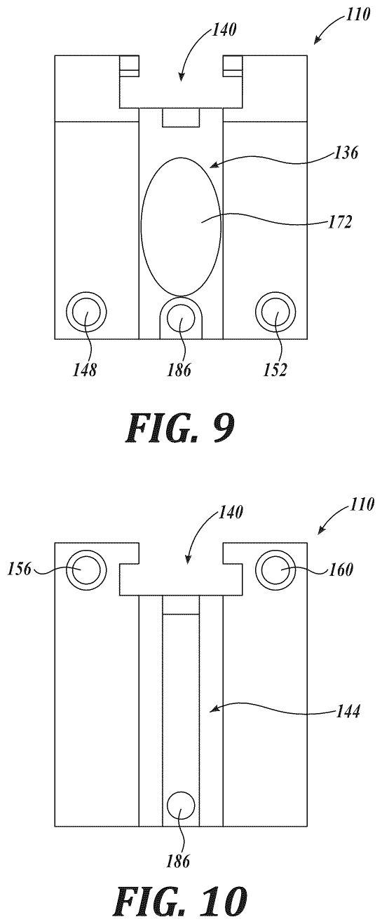

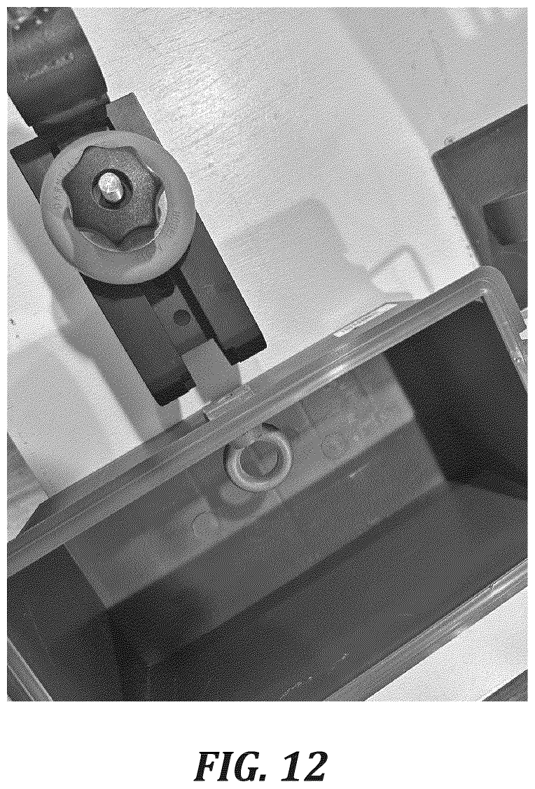

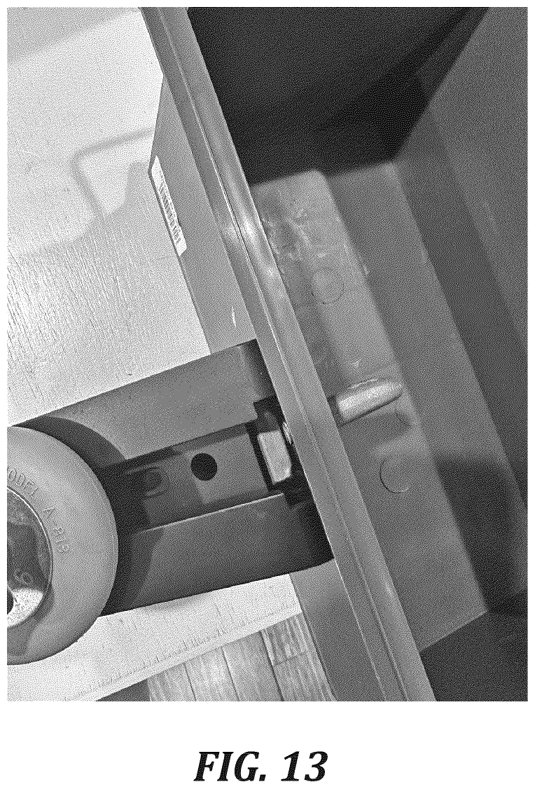

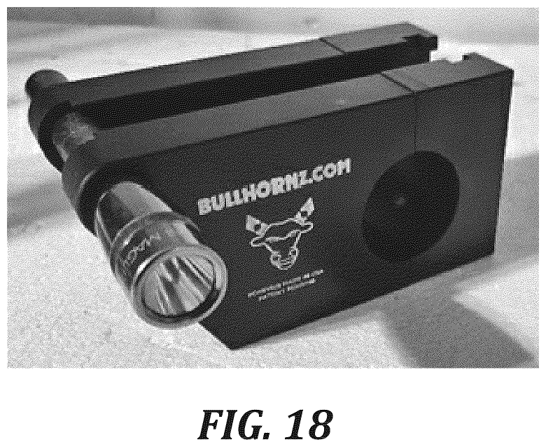

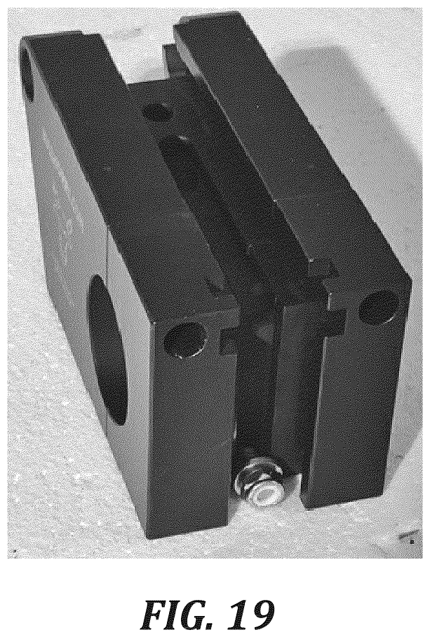

FIGS. 2A-2C and 3-18 depict an exemplary embodiment of a bull bar accessory attachment system 100 formed in accordance with the present disclosure. Generally, the bull bar accessory attachment system 100 is configured to securely mount bull bar accessories to a bull bar. In other words, the bull bar accessory attachment system 100 can be used to mount bull bar accessories to a bull bar in a manner that substantially prevents at least some of the accessories from being stolen. Further, the bull bar accessory attachment system 100 is configured to provide versatility in mounting bull bar accessories to a bull bar, such as enabling multiple accessories to be mounted to the bull bar. Further, the bull bar accessory attachment system 100 includes enhanced safety features that help prevent detachment of accessories from the system in the event of a crash and/or during installation. Other benefits will also become more appreciated from the description that follows.

The bull bar accessory attachment system 100 includes at least one mounting module 110 that is used to securely mount at least one bull bar accessory to a bull bar. For instance, as shown in FIGS. 2A-2C, the bull bar accessory attachment system 100 includes first and second mounting modules 110, each securely mounting a road light L, a tool box B, a shovel holder S, and a jack lift mount J to the bull bar 120. It should be appreciated that any other combination of accessories may instead be mounted to the bull bar 120 using the bull bar accessory attachment system 100.

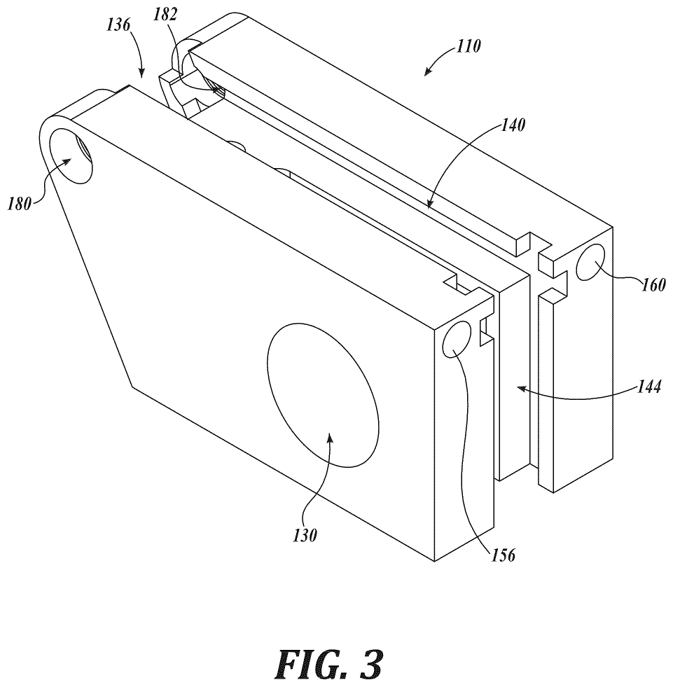

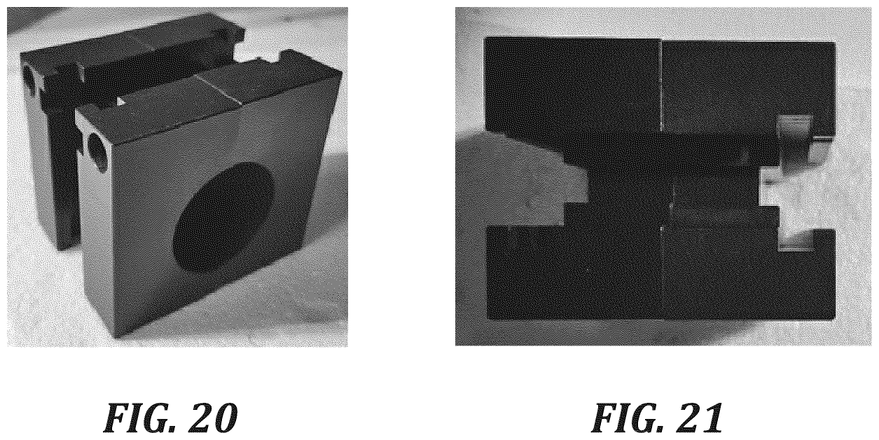

Detailed aspects of the at least one mounting module 110 will now be described with reference to FIGS. 3-10. In the examples shown, each mounting module 110 is generally square or rectangular in overall shape having an optionally tapered front side. For instance, the mounting module 110 may be rectangular in overall shape with an optionally tapered front side, as shown in FIGS. 3-10, such that if a toolbox or similar accessory is mounted to the front side, clearance is provided for opening the toolbox (e.g., pivoting the lid around its hinge). In other examples, the mounting module 110 may be generally square in overall shape, as shown in FIGS. 20 and 21. It should be appreciated that other shapes and sizes than that shown may be used without departing from the spirit and scope of the present disclosure.

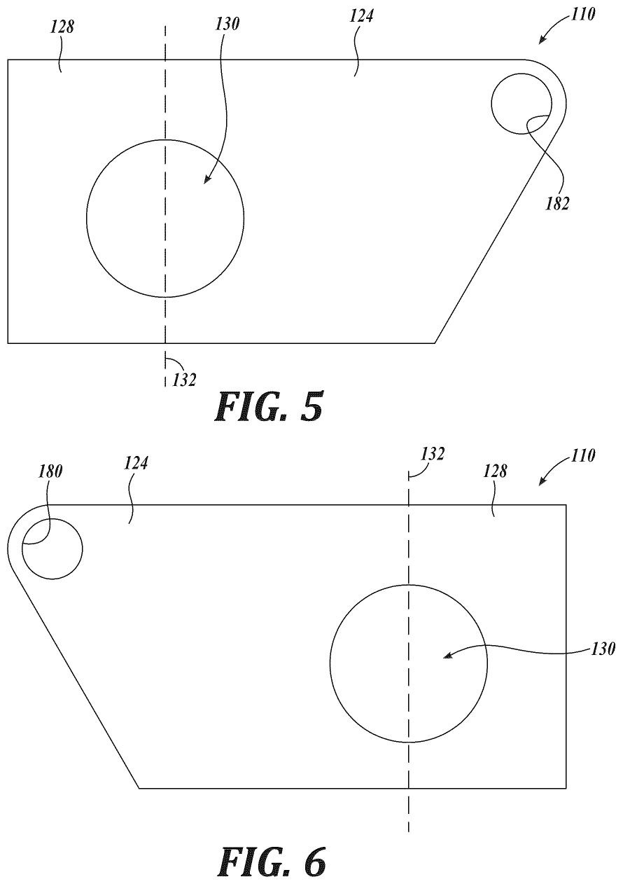

The mounting module 110 includes a first mounting portion 124 and a second mounting portion 128 that, when secured together, define an opening 130 that receives a tube of the bull bar. For ease of illustration, the at least one mounting module 110 is shown as a single formed piece, with a cut line 132 defining the first and second mounting portions 124 and 128 shown in FIGS. 5 and 6. The separated first and second mounting portions 124 and 128 are shown in the various photographs of the FIGS. The first and second mounting portions 124 and 128 of the mounting module 110 may be made from a solid piece of metal or other sturdy material.

Each mounting module 110 includes at least one slot attachment assembly that is configured to removable and securely attach at least one bull bar accessory to the bull bar. In the example shown, the mounting module 110 includes a first slot attachment assembly 136 defined in a front, leading side of the mounting module 110, a second slot attachment assembly 140 defined in a top side of the mounting module 110, and a third slot attachment assembly 144 defined in a rear side of the mounting module 110.

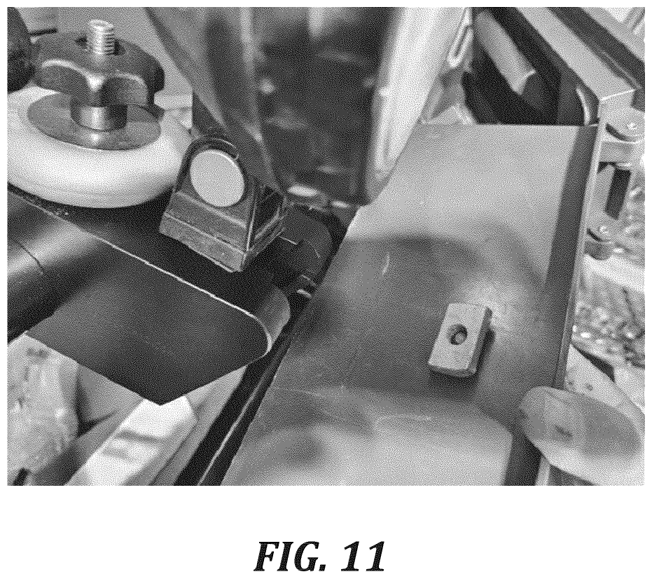

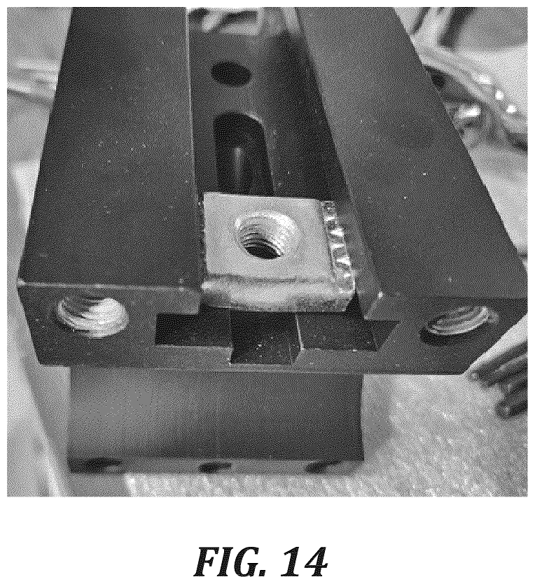

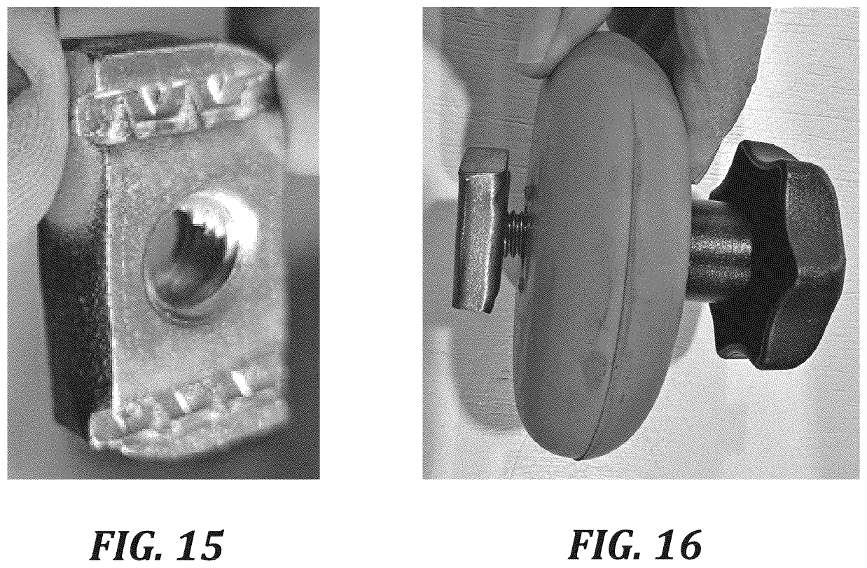

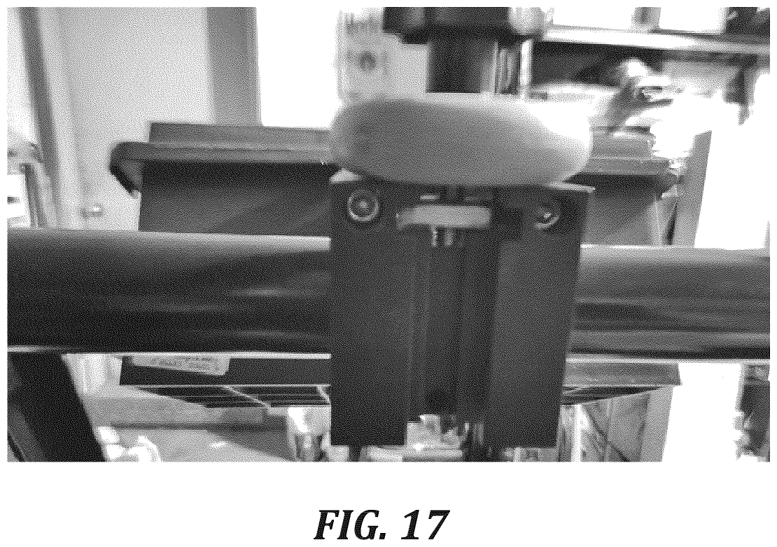

Each of the slot attachment assemblies include a slot extending along the corresponding face of the mounting module 110. Each slot is generally T-shaped in cross-section to slidably receive a slide nut (or T nut) therein (see FIGS. 11-17). In that regard, an accessory may be bolted to the mounting module 110 by passing a bolt through a hole in the accessory and threadably securing an end of the bolt to the slide nut (see FIGS. 11-13 showing a toolbox being mounted to a mounting module, FIGS. 16 and 17 showing a lift jack mount being mounted to a mounting module). Moreover, with the ability of the slide nut to move along the length of the slot attachment assembly when loosely secured to the bolt, the location of the accessory may be adjusted relative to the mounting module 110 (see FIG. 14 showing a slide nut received within a slot and FIG. 15 showing a slide nut in isolation). An additional recess may be defined at the bottom of each of the slot attachment assemblies to provide needed clearance for fasteners (e.g., bolt ends).

The first and second mounting portions 124 and 128 are secured together in a manner that substantially prevents disassembly of the mounting module 110 from the bull bar when an accessory is secured to at least one of the front or rear side of the mounting module 110. More specifically, the first and second mounting portions 124 and 128 are secured together in a manner that substantially prevents them from being separated from unauthorized users when an accessory is secured to at least one of the front or rear side of the mounting module 110.

In the example shown, first and second longitudinal through-bolt holes 148 and 152 extend through the length of the mounting module 110 from the front side toward the rear side, across the interface of the first and second mounting portions 124 and 128. Further, third and fourth longitudinal through-bolt holes 156 and 160 extend through the length of the mounting module 110 from the rear side to the front side, across the interface of the first and second mounting portions 124 and 128. In the example shown, the first, second, third, and fourth longitudinal through-bolt holes 148, 152, 156, and 160 are generally located at the four corners of the mounting module 110.

A through bolt (see FIGS. 14 and 17) may be secured in each of the longitudinal through-bolt holes to secure the first and second mounting portions 124 and 128 together. However, if an accessory is secured to the front or rear face of the mounting module 110, as will be described more below, the corresponding through bolts cannot be accessed. As a result, the mounting module 110 cannot be removed from a bull bar from an unauthorized user with an accessory attached to at least one of the front or rear sides.

Referring to FIGS. 11-13, a toolbox may be secured to a front side of the mounting module 110 using the slide nut and first slot attachment assembly 136 described above. For instance, a threaded end of a bolt may be passed through an opening in a side of the toolbox and threaded into a slide nut received in the first slot attachment assembly 136. The head of the bolt (which may be a knob or other gripping configuration if the bolt is a hand bolt) is only accessible from the interior of the box. In that regard, the box may then be locked to prevent access to the bolt head and therefore its removal from the mounting module 110. Moreover, with the toolbox or another lockable accessory secured to the front side of the mounting module 110, the first and second through-bolt holes 148 and 152 cannot be accessed for disassembling the mounting module 110 or otherwise removing it from the bull bar.

The mounting module 110 further includes a lock mount assembly 164 for lockingly securing an accessory (such as a light assembly) to the mounting module 110. The lock mount assembly 164 is defined in part by a transverse through-hole 168 extending through the mounting module 110 from its top side toward its bottom side. The transverse through-hole 168 may extend from a bottom of the second slot attachment assembly 140 to the first slot attachment assembly 136. In that regard, a bottom of the transverse through-hole 168 interfaces with the first slot attachment assembly 136. The transverse through-hole 168 is configured to receive a threaded end of a fastener such as a through-bolt (e.g., extending through a light assembly).

A counter bore 172 may surround the bottom of the transverse through-hole 168 to limit access to any nut secured to an end of a through-bolt extending through the transverse through-hole 168. For instance, the nut may be removed from the end of a through-bolt extending through the transverse through-hole 168 with only certain tools, such as a specific socket wrench.

The lock mount assembly 164 may also be defined in part by a lockable accessory, such as a toolbox, secured to the front side of the mounting module 110. With a toolbox secured to the front side of the mounting module 110, access to a nut secured to an end of a through-bolt extending through the transverse through-hole 168 is prevented. In that regard, the nut secured to an end of a through-bolt extending through the transverse through-hole 168 can only be removed if the toolbox is unlocked and removed.

A wire access opening 176 may extend from a bottom of the second slot attachment assembly 140 to the opening 130. In this manner, any wires of the accessory (e.g., the light assembly) may be fed through the wire access opening 176 for connection to the vehicle. The wire access opening 176 may be used as a drill guide to drill a hole in the tube of the bull bar 120. As such, the wire may be fed through the mounting module 110 and into the interior of the bull bar 120 for a clean installation (also preventing wires from getting caught on objects such as trees).

Transverse through-holes 180 and 182 may be defined in an upper corner of the mounting module 110 to allow for a flashlight or other device (e.g., a fire starter) to be secured therein. In that regard, a flashlight would generally extend transversely across forward end of the second slot attachment assembly 140. In this manner, in the event of a collision, a flashlight or other device secured in the through-holes 180 and 182 may help prevent forward ejection of any accessories received in the second slot attachment assembly 140.

Along the same lines, a pin (see FIG. 19) may extend within a bottom through-hole 186 defined along the bottom side of the mounting module 110 and intersecting the first slot attachment assembly 136 and the second slot attachment assembly 140. The pin may protrude from the open ends of the bottom through-hole 186 such that it defines interference for any slide nuts received within the first slot attachment assembly 136 and third slot attachment assembly 144. Thus, the pin may prevent the slide nuts from sliding or falling out of the bottom of the slot attachment assemblies, providing support during installation.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, the terms “about” and “approximately,” in reference to a number, is used herein to include numbers that fall within a range of 10%, 5%, or 1% in either direction (greater than or less than) the number unless otherwise stated or otherwise evident from the context (except where such number would exceed 100% of a possible value).

Language such as “top”, “bottom”, “upper”, “lower”, “vertical”, “horizontal”, “lateral”, etc., in the present disclosure is meant to provide orientation for the reader with reference to the drawings and is not intended to be the required orientation of the components or to impart orientation limitations into the claims.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term.

Likewise, the disclosure is not limited to various example embodiments given in this specification. Unless otherwise defined, technical and scientific terms used herein have the meaning as commonly understood by one of ordinary skill in the art to which this disclosure.

While illustrative embodiments have been illustrated and described, it will be appreciated that various changes can be made therein without departing from the spirit and scope of the invention.

1. A bull bar mounting module configured to secure at least one accessory to a bull bar, comprising:
a front side, a top side, a rear side, and a bottom side;
a first slot attachment assembly defined in the front side and a third slot attachment assembly defined in the rear side;
at least first and second mounting portions that are secured together in a manner that substantially prevents disassembly of the mounting module from a bull bar when an accessory is secured to at least one of the front or rear side of the mounting module using the corresponding slot assembly.

2. The bull bar mounting module of claim 1, further comprising a lock mount assembly configured to lockingly secure an accessory to a second slot attachment assembly defined on the top side when an accessory is mounted to one of the front or rear side of the mounting module using the corresponding slot assembly.
